(19) United States
(12) Patent Application Publication
(10) Pub. No.: US 2026/0091747 A1
(43) Pub. Date: Apr. 2, 2026

(54) FLUID DISTRIBUTION MODULE FOR A THERMAL MANAGEMENT SYSTEM

(71) Applicant: Hanon Systems, Daejeon (KR)

(72) Inventors: JiChul Lee, Sterling Heights, MI (US); Aaron Hawksley, Dearborn Hts, MI (US); Edward William Sanders III, Monroe, MI (US); Evan Wang Delosh, Ann Arbor, MI (US)

(21) Appl. No.: 19/211,658

(22) Filed: May 19, 2025

Related U.S. Application Data
(60) Provisional application No. 63/700,017, filed on Sep. 27, 2024.

(51) Int. Cl. B60R 16/08; B60K 11/02; F16K 11/22; H01M 10/613; H01M 10/625; H01M 10/6568

(52) U.S. Cl. CPC B60R 16/08; F16K 11/22; H01M 10/613; H01M 10/625; H01M 10/6568; B60K 11/02

(57) ABSTRACT

A multi-mode fluid distribution module for selectively controlling a flow of one or more fluids through a thermal management system is disclosed. The module includes a fluid valve system in fluid communication with one or more fluid manifolds. The fluid valve system includes a pair of actuators operably coupled an associated pair of fluid valve assemblies disposed in a housing defining a plurality of flow paths. Each of the fluid valve assemblies includes a plurality of flow control members in stacked relationship moveably disposed and selectively positionable within the housing to achieve various operating modes of the fluid distribution module, and thereby, the thermal management system.

### CROSS-REFERENCE TO RELATED APPLICATION

This application claims the benefit of U.S. Provisional Patent Application Ser. No. 63/700,017, filed Sep. 27, 2024, the entirety of which is herein incorporated by reference.

### FIELD

The disclosure relates to a thermal management system, and more particularly to a multi-mode fluid distribution module for a thermal management system.

### BACKGROUND

Vehicle heat exchangers, such as radiators, have valves that are used to control the rate that a fluid such as coolant, for example, is allowed to flow through the system. With the increase in government mandated fuel economy regulations, companies are increasingly looking for new technology that will reduce the parasitic losses and improve efficiency of internal combustion engines. Furthermore, the introduction of hybrid and fully electric vehicle powertrains has introduced powertrain and thermal management complexities due to the need to control the temperature of batteries, inverter electronics, electric motors, etc. These trends lead to the need for more intelligently controlled fluid valve systems.

Conventional valve systems include diverter balls, cylinders, and the like to enable the heat exchangers to receive various intake and exhaust flows. As such, a single heat exchanger may function as a charge air cooler (CAC), exhaust gas recirculation (EGR) cooler, and heat recovery device. While these designs may provide adequate performance for proportional flow applications, they do have some drawbacks. For example, some conventional valve systems have one actuator controlling a single diverter valve, which for multiple modes of operation require numerous actuators and diverter valves that consume valuable packaging space in a vehicle.

Accordingly, it would be desirable to produce a multi-mode fluid distribution module for a thermal management system wherein a size, weight, and cost thereof are minimized, while optimizing a performance and function of the thermal management system.

### SUMMARY

In concordance and agreement with the presently described subject matter, a multi-mode fluid distribution module for a thermal management system, which minimizes a size, weight, and cost thereof, while optimizing a performance and function thereof, has been newly designed.

In one embodiment, a fluid valve system, comprises: a first valve assembly including a first flow control member and a second flow control member in stacked relationship with the first flow control member, wherein the second flow control member is configured to be driven by the first flow control member, and wherein the first flow control member is configured to operably engage and rotate substantially independently from the second control member; and a second valve assembly including a third flow control member and a fourth flow control member in stacked relationship with the third flow control member, wherein the third flow control member is configured to be driven by the fourth flow control member, wherein the fourth flow control member is configured to operably engage and rotate substantially independently from the third control member.

In another embodiment, a module, comprises: at least one fluid manifold; and a fluid valve system in fluid communication with the at least one fluid manifold, wherein the module is configured to selectively control a flow of one or more fluids through a thermal management system, wherein the fluid valve system comprises: a housing; a first valve assembly disposed in the housing, the first valve assembly including a first flow control member and a second flow control member in stacked relationship with the first flow control member, wherein the second flow control member is configured to be driven by the first flow control member, and wherein the first flow control member is configured to operably engage and rotate substantially independently from the second control member; and a second valve assembly disposed in the housing, the second valve assembly including a third flow control member and a fourth flow control member in stacked relationship with the third flow control member, wherein the third flow control member is configured to be driven by the fourth flow control member, wherein the fourth flow control member is configured to operably engage and rotate substantially independently from the third control member.

In yet another embodiment, a method of operating a module, comprises: providing a module comprising at least one fluid manifold and a fluid valve system, the fluid valve system comprising: a housing; a first valve assembly disposed in the housing, the first valve assembly including a first flow control member and a second flow control member in stacked relationship with the first flow control member, wherein the second flow control member is configured to be driven by the first flow control member, and wherein the first flow control member is configured to operably engage and rotate substantially independently from the second control member; and a second valve assembly disposed in the housing, the second valve assembly including a third flow control member and a fourth flow control member in stacked relationship with the third flow control member, wherein the third flow control member is configured to be driven by the fourth flow control member, wherein the fourth flow control member is configured to operably engage and rotate substantially independently from the third control member; causing a rotational movement of the first flow control member in a first direction to selectively position the second flow control member in a desired position; causing a rotational movement of the first flow control member in an opposite second direction to selectively position the first control member in a desired position; causing a rotational movement of the fourth flow control member in the first direction to selectively position the third flow control member in a desired position; and causing a rotational movement of the fourth flow control member in the second direction to selectively position the fourth control member in a desired position; wherein the module is configured to operate in at least three modes.

As aspects of some embodiments, the first flow control member is configured to be driven by an actuator.

As aspects of some embodiments, at least one of the first flow control member and the second flow control member includes a main body having at least fluid passageway formed therein.

As aspects of some embodiments, the second flow control member comprises a first level including one or more fluid passageways and one or more fluid openings and a second level including one or more fluid passageways and one or more fluid openings.

As aspects of some embodiments, the fourth flow control member is configured to be driven by an actuator.

As aspects of some embodiments, at least one of the third flow control member and the fourth flow control member includes a main body having at least fluid passageway formed therein.

As aspects of some embodiments, further comprising a degassing connection formed in a housing of the fluid valve system.

As aspects of some embodiments, the third flow control member selectively opens and closes the degassing connection.

As aspects of some embodiments, the first fluid valve assembly is configured to be independently operated from the second fluid valve assembly.

As aspects of some embodiments, a position of at least one of the flow control members depends on an operating mode of the thermal management system.

As aspects of some embodiments, the operating mode is a Mode A that permits a fluid distribution in series through the chiller or the cooler core (CC), the low temperature radiator (LTR) and a fluid distribution in series through the battery, a powertrain and the water-cooled chiller (WCC) and/or the heater core (HC).

As aspects of some embodiments, the operating mode is a Mode S that permits a fluid distribution in series through the power source, powertrain, and the water-cooled chiller (WCC) and/or the heater core (HC).

As aspects of some embodiments, the operating mode is a Mode P that permits a fluid distribution in parallel through the power source, the powertrain, and the water-cooled chiller (WCC) and/or the heater core (HC).

As aspects of some embodiments, each of the flow control members includes a main body having at least fluid passageway formed therein.

As aspects of some embodiments, the module further comprising a degassing connection formed in a housing of the fluid valve system.

As aspects of some embodiments, the third flow control member selectively opens and closes the degassing connection.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a vehicle interface side perspective view of a multi-mode fluid distribution module according to an embodiment of the present disclosure, wherein the module includes a fluid valve system in fluid communication with first and second fluid manifolds to selectively control a flow of one or more fluids through a thermal management system;

FIG. 2 is a refrigerant thermal management system (RTMS) side perspective view of the module of FIG. 1;

FIG. 3 is a rotated sectional view of a portion the module of FIGS. 1 and 2, showing the fluid valve system in a vertical position;

FIG. 4 is an elevational view of the fluid valve system of FIGS. 1-3, wherein a housing thereof is omitted;

FIG. 5 is a side perspective view of the fluid valve system of FIGS. 1-4, wherein the housing is omitted and each of a first valve assembly and a second valve assembly is identified by dashed lines;

FIG. 6 is a sectional view of a flow control member of the first valve assembly of FIG. 5, showing an interlocking feature;

FIG. 7 is a table indicating valve positions of the fluid valve assemblies during various operating modes of the module of FIG. 1, wherein the valve positions are indicated in degrees of rotation;

FIG. 8 is a first manifold interface side perspective of the fluid valve system of FIGS. 1-5, wherein the housing include various fluid flow paths;

FIG. 9 is a second manifold interface side perspective of the fluid valve system of FIGS. 1-5, wherein the housing include various fluid flow paths;

FIG. 10A is a sectional view of a flow control member of the first valve assembly of FIG. 5 during an operating Mode A of the module of FIG. 1, showing a position of fluid passageways and fluid openings within a first level of the flow control member during Mode A;

FIG. 10B is a sectional view of the flow control member of the first valve assembly of FIG. 5 during an operating Mode A of the module of FIG. 1, showing a position of fluid passageways and fluid openings within a second level of the flow control member during Mode A;

FIG. 11A is a sectional view of the flow control member of the first valve assembly of FIG. 5 during an operating Mode S of the module of FIG. 1, showing a position of fluid passageways and fluid openings within the first level of the flow control member during Mode S;

FIG. 11B is a sectional view of the flow control member of the first valve assembly of FIG. 5 during an operating Mode S of the module of FIG. 1, showing a position of fluid passageways and fluid openings within the second level of the flow control member during Mode S;

FIG. 12A is a sectional view of the flow control member of the first valve assembly of FIG. 5 during an operating Mode P of the module of FIG. 1, showing a position of fluid passageways and fluid openings within the first level of the flow control member during Mode P;

FIG. 12B is a sectional view of the flow control member of the first valve assembly of FIG. 5 during an operating Mode P of the module of FIG. 1, showing a position of fluid passageways and fluid openings within the second level of the flow control member during Mode P;

FIGS. 13A and 13B are sectional views of a flow control member of the second valve assembly of FIG. 5 during an operating Mode S of the module of FIG. 1, showing a position of fluid passageways and fluid openings within the flow control member and a degassing connection “OFF” during Mode S; and

FIGS. 14A and 14B are sectional views of the flow control member of the second valve assembly of FIG. 5 during an operating Mode P and/or Mode A of the module of FIG. 1, showing a position of fluid passageways and fluid openings within the flow control member and a degassing connection “ON” during Mode P and/or Mode A.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

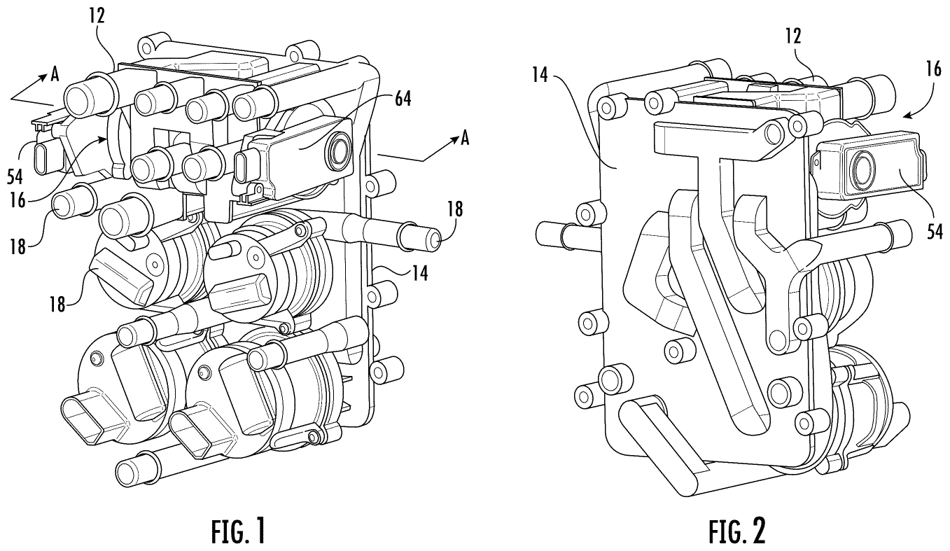

FIGS. 1 and 2 illustrate a multi-mode fluid distribution module 10 according to an embodiment of the present disclosure. Preferably, the module 10 may be configured for a thermal management system (not depicted) of an electric or hybrid vehicle. It is understood that the module 10 may be coupled to any component and/or subsystem of the thermal management system by any method and means as desired. The module 10 may be configured to selectively control a flow of one or more fluids (e.g., coolant, refrigerant) through the thermal management system. It should be appreciated, however, that the module 10 may be employed in other fluid-flow control applications as desired.

The module 10 may include first and second fluid manifolds 12, 14, respectively, disposed on opposing sides of a fluid valve system 16. In some embodiments, the first fluid manifold 12 of the module 10, shown in FIG. 1, is configured for fluid communication with a vehicle interface and the second fluid manifold 14 of the module 10, shown in FIG. 2, is configured for fluid communication with a refrigerant thermal management system (RTMS). Each of the fluid manifolds 12, 14 may include one or more openings 18 formed therein. In some embodiments, the openings 18 may perform as ports to provide fluid communication between the module 10 and various components of the thermal management system. It is understood that the openings 18 may be formed at other locations in the fluid manifolds 12, 14 than shown. It is also understood that each of the fluid manifolds 12, 14 may have any size, shape, and configuration as desired to optimize a performance and function of the module 10, and thereby the thermal management system.

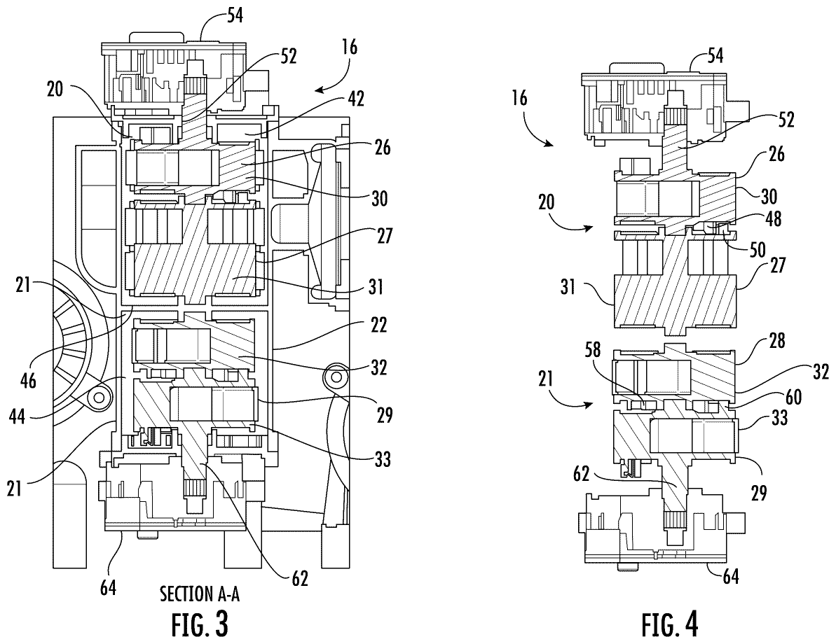

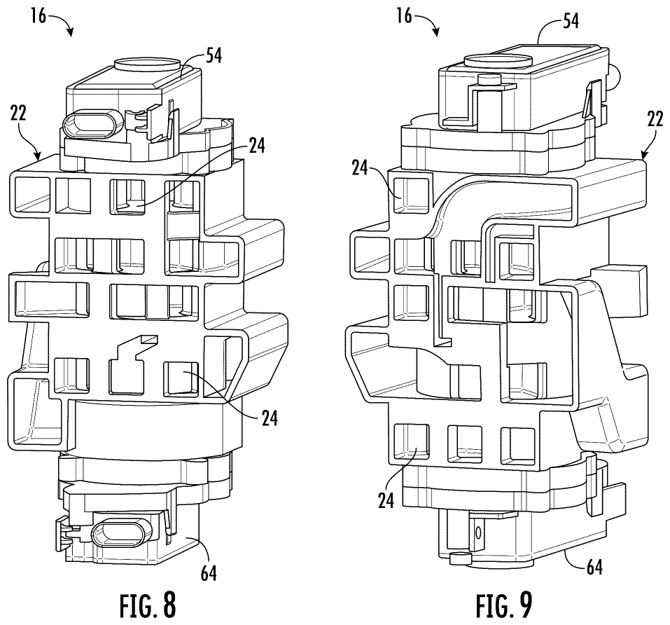

In some embodiments shown in FIGS. 3-5, the fluid valve system 16 comprises a first valve assembly 20 and a second valve assembly 21 arranged in stacked relationship and disposed in a housing 22 defining a plurality of fluid flow paths 24 (depicted in FIGS. 8 and 9). Each of the fluid flow paths 24 may be in fluid communication with one or more of the openings 18 formed at least one of the fluid manifolds 12, 14 of the module 10. More or less fluid valve assemblies than shown may be employed in the module 10 if desired. As best shown in FIGS. 3-5, the first valve assembly 20 may include a flow control member 26 and a flow control member 27 and the second valve assembly 21 may include a flow control member 28 and a flow control member 29. Each of the flow control members 26, 27, 28, 29 is moveably disposed and selectively positionable within the housing 22 to achieve various operating modes of the module 10, and thereby, optimize performance and function of the thermal management system.

In certain embodiments, the flow control members 26, 27, 28, 29, each may comprise a main body 30, 31, 32, 33, respectively. Each of the main bodies 30, 31, 32, 33 may have a generally cylindrical shape. However, it is understood that the main bodies 30, 31, 32, 33, each may have any suitable shape as desired. Each of the main bodies 30, 31, 32, 33 may be a unitary structure or formed from multiple components, if desired. It is also understood that the main bodies 30, 31, 32, 33 may be formed from any suitable material such as a metal, a non-metal (e.g., plastic), and the like, or a combination thereof, for example. The main bodies 30, 31, 32, 33 may be formed by a molding process, an additive process (e.g. a three-dimensional printing process), a subtractive process (e.g., a machining process), or any other forming or manufacturing process, or a combination thereof, as desired.

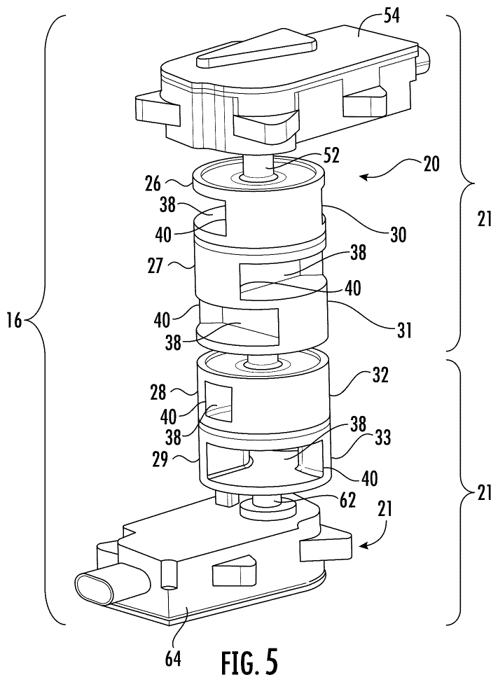

In some embodiments, one or more of the main bodies 30, 31, 32, 33 may have one or more fluid passageways 38 formed therein to receive a flow of a fluid therethrough. Each of the fluid passageways 38 may include one or more fluid openings 40. Additional fluid openings 40 may be formed in the main bodies 30, 31, 32, 33 of the flow control members 26, 27, 28, 29, if desired. In the embodiment shown, the main body 31 of the flow control member 27 may be have a first level and a second level, each level having separate and distinct fluid passageways 38 and fluid openings 40 within the main body 31. Each of the fluid openings 40 may function as a fluid inlet and/or a fluid outlet during operation of the fluid valve system 16. As best seen in FIGS. 4 and 5, a cross-sectional area of each of the fluid openings 40 may vary and a cross-sectional shape of each of the fluid openings 40 may be non-circular. The cross-sectional area and shape of the fluid passageways 38 and/or the fluid openings 40 facilitates proportional flow through the fluid valve system 16 and the module 10. It should be appreciated that the shape, size, and configuration of the flow control members 26, 27, 28, 29 of the fluid valve system 16 results in simplified manufacture (e.g., a molding process, a three-dimensional printing process, a machining process, or any other forming process, or a combination thereof, as desired) and sealing structure of the fluid valve system 16 as well as a compact shape, size, and configuration of the module 10.

The housing 22, shown in FIG. 3, of the fluid valve system 16 may include a pair of chambers 42, 44 separated by a divider 46 and configured to receive a respective one of the fluid valve assemblies 20, 21. It should be appreciated that each of the chambers 42, 44 may have any size and shape as desired to receive the respective one of the fluid valve assemblies 20, 21 therein. The flow control members 26, 27 for the first fluid valve assembly 20 may be moveably disposed in the chamber 42 of the housing 22 and the flow control members 28, 29 may be moveably disposed in the chamber 44 of the housing 22 so that during certain operating modes of the module 10 and thermal management system, at least one of the fluid openings 40 of the fluid passageways 38 of the flow control members 26, 27, 28, 29 is generally aligned with one or more fluid flow paths 24 of the housing 22, for example, at least one fluid inlet formed in an outer wall of the housing 22 and at least one of the fluid openings 40 of the fluid passageways 38 of the flow control members 26, 27, 28, 29 is generally aligned with at least one fluid outlet formed in the outer wall of the housing 22. In addition to the fluid flow paths 24, the fluid inlets and the fluid outlets formed in the housing 22 of the fluid valve system 16 may be in fluid communication with the openings 18 of the fluid manifolds 12, 14.

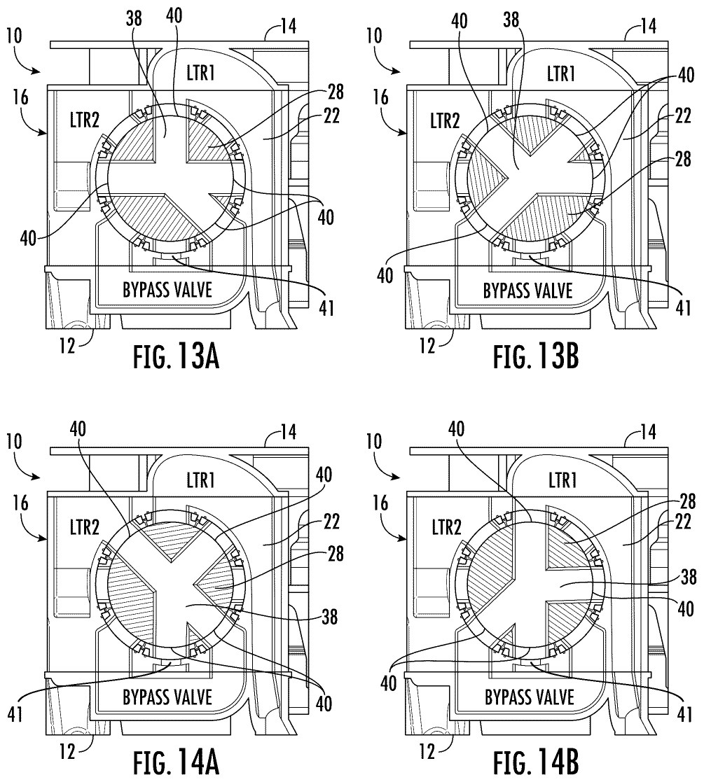

In certain embodiments, the module 10 may further comprise a degassing connection 41 (depicted in FIGS. 13A-14B) to facilitate venting or removal of trapped air or gasses therefrom. The degassing connection 41 may be formed in the housing 22 of the fluid valve system 16. It is understood that the degassing connection 41 may be formed elsewhere in the module 10 if desired. In a non-limiting example, the flow control member 28 may be configured to selectively close and open the degassing connection 41 between a respective “OFF” position, as shown in FIGS. 13A and 13B, and “ON” position, as shown in FIGS. 14A and 14B. It is understood that at least one of the other flow control members 26, 27, 29 or other components of the module 10 may be used to selectively close and open the degassing connection 41 if desired.

In some embodiments, the module 10, and more particularly the housing 22 of the fluid valve system 16, may include electronic water pumps mounted directly and operating integral to the functioning of the fluid valve assemblies 20, 21. It is understood, however, that the electronic water pumps may be disposed elsewhere and/or mounted on the module 10 at various other locations.

One or more sealing elements (e.g. O-rings, gaskets, elastomeric seals, and the like), may be disposed between at least one of the flow control members 26, 27, 28, 29 of at least one of the fluid valve assemblies 20, 21 and an inner surface of the housing 22 to form a substantially fluid-tight seal therebetween and militate against an undesired leakage of the fluid around a periphery of the fluid openings 40 of the fluid passageways 38. It is understood that various other sealing methods may be employed if desired.

Each of the flow control members 26, 27, 28, 29 of the fluid valve assemblies 20, 21 may be individually and/or selectively positionable within the housing 22 of the fluid valve system 16 and configured to selectively control the flow of the one or more fluids therethrough. In certain embodiments, the flow control members 26, 27 of the first valve assembly 20 and the flow control members 28, 29 of the second valve assembly 21 are in a stacked relationship within the chamber of the housing 22.

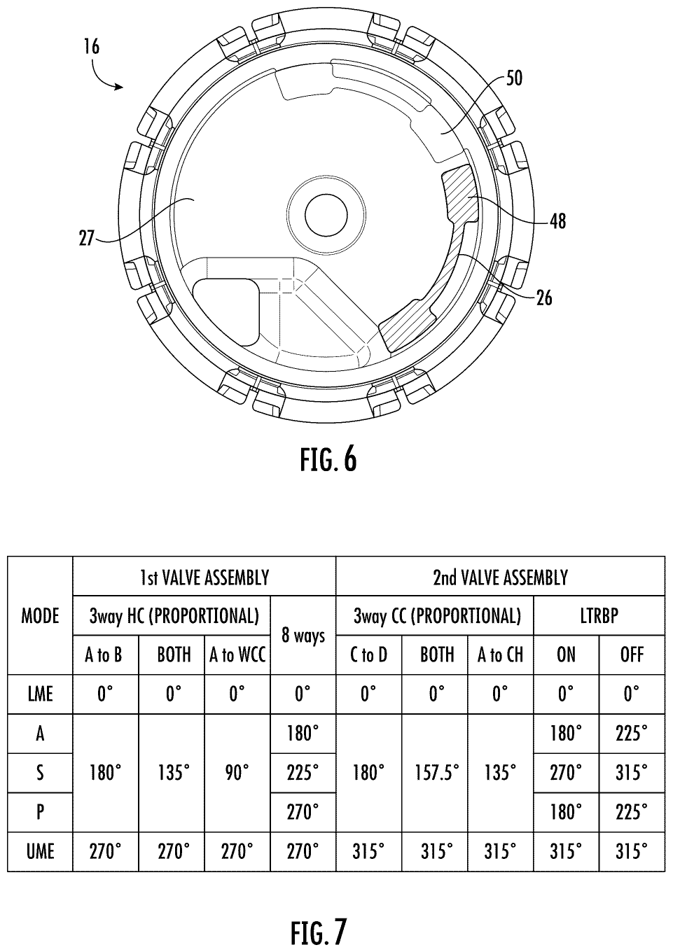

As best seen in FIGS. 4 and 6, the main body 30 of the flow control member 26 may include one more positioning elements 48 and the main body 31 of the flow control member 27 may include one or more corresponding positioning elements 50. Each of the positioning elements 48, 50 may extend outwardly and axially parallel to a rotational axis of the respective one of the main bodies 30, 31. As depicted, the positioning elements 48 of the flow control member 26 may extend from a surface of the main body 30 in a first direction towards the flow control member 27 and the positioning elements 50 of the flow control member 27 may extend from a surface of the main body 31 in an opposite second direction towards the flow control member 26 to permit selective engagement therebetween during positioning of the flow control members 26, 27.

The flow control members 26, 27 in the stacked relationship are configured to rotate in unison or substantially simultaneously when the positioning elements 48 of the flow control member 26 engage the positioning elements 50 of the flow control member 27. When the positioning elements 48, 50 are disengaged, the flow control member 26 of the fluid valve assembly 20 may be operated proportionally of the flow control member 27 of the fluid valve assembly 20. Thus, the flow control member 26 may rotate independently while the flow control member 27 remains stationary. In a non-limiting example, the flow control member 26 is caused to move in the first rotational direction until the positioning elements 48 thereof engage the positioning elements 50 of the flow control member 27. Once the positioning elements 48, 50 engage, the flow control members 26, 27 rotate substantially simultaneously in the first rotational direction until a desired position of the flow control member 27 is reached. In some circumstances, a desired position of the flow control member 26 may not be achieved during the positioning of the flow control member 27 in its desired position. Accordingly, the flow control member 26 may then be caused to move in the opposite second rotational direction to disengage the positioning elements 48, 50 so that the desired position of the flow control member 27 is maintained while the flow control member 26 is rotated. The flow control member 26 may then continue to rotate in the second rotational direction until the desired position thereof is reached.

Each of the flow control members 26, 27 may be selectively positioned between 0 and 360 degrees about the rotational axis thereof. However, in some embodiments, each of the flow control members 26, 27 may interface with one or more drive stops during the positioning thereof. The drive stops may be configured to prevent at least one of the flow control members 26, 27 from rotating the full 360 degrees about the rotational axis thereof and/or define a range of rotational movement of the flow control member 26, 27. As a non-limiting example, at least one of the flow control members 26, 27 may interface with one or more drive stops during the positioning thereof to limit a range of rotational movement as well as militate against over-rotation. In preferred embodiments, each of the flow control members 26, 27 of the fluid valve assembly 20 may be positioned in a desired position.

At least one driven element 52, for example a driven gear, a pinion, etc., may be formed on the main body 30 of the flow control member 26. It is understood, however, that the driven element may be formed on the main body 31 of the flow control member 27, if desired. The driven element 52 may extend outwardly and axially along the rotational axis of the main body 30. The driven element 52 may be configured to be coupled to a driving element or actuator 54 to cause the rotational movement of one or more of the flow control members 26, 27 about the rotational axis thereof in the first rotational direction and the opposite second rotational direction. The driving element/actuator 54 may be powered by any electric motor with an ability to generate rotary motion. For example, the driving element/actuator 54 may be driven by a stepper motor or a brushless DC (BLDC) motor. It is understood that other methods of actuation and causing the rotational movement of the flow control members 26, 27 within the fluid valve system 16 may be used.

Similarly, the main body 32 of the flow control member 28 may include one more positioning elements 58 and the main body 33 of the flow control member 29 may include one or more corresponding positioning elements 60. Each of the positioning elements 58, 60 may extend outwardly and axially along a rotational axis of the respective one of the main bodies 32, 33. As depicted, the positioning elements 58 of the flow control member 28 may extend from a surface of the main body 32 in a first direction towards the flow control member 29 and the positioning elements 60 of the flow control member 29 may extend from a surface of the main body 33 in an opposite second direction towards the flow control member 28 to permit selective engagement therebetween during positioning of the flow control members 28, 29.

The flow control members 28, 29 in the stacked relationship are configured to rotate in unison or substantially simultaneously when the positioning elements 58 of the flow control member 28 engage the positioning elements 60 of the flow control member 29. When the positioning elements 58, 60 are disengaged, the flow control member 29 of the fluid valve assembly 21 may be operated proportionally of the flow control member 28 of the fluid valve assembly 21. Thus, the flow control member 29 may rotate independently while the flow control member 28 remains stationary. In a non-limiting example, the flow control member 29 is caused to move in the first rotational direction until the positioning elements 60 thereof engage the positioning elements 58 of the flow control member 27. Once the positioning elements 58, 60 engage, the flow control members 28, 29 rotate substantially simultaneously in the first rotational direction until a desired position of the flow control member 28 is reached. In some circumstances, a desired position of the flow control member 29 may not be achieved during the positioning of the flow control member 28 in its desired position. Accordingly, the flow control member 29 may then be caused to move in the opposite second rotational direction to disengage the positioning elements 58, 60 so that the desired position of the flow control member 28 is maintained while the flow control member 29 is rotated. The flow control member 29 may then continue to rotate in the second rotational direction until the desired position thereof is reached.

Each of the flow control members 28, 29 may be selectively positioned between 0 and 360 degrees about the rotational axis thereof. However, in some embodiments, each of the flow control members 28, 29 may interface with one or more drive stops during the positioning thereof. The drive stops may be configured to prevent at least one of the flow control members 28, 29 from rotating the full 360 degrees about the rotational axis thereof and/or define a range of rotational movement of the flow control member 28, 29. As a non-limiting example, at least one of the flow control members 28, 29 may interface with one or more drive stops during the positioning thereof to limit a range of rotational movement as well as militate against over-rotation. In preferred embodiments, each of the flow control members 28, 29 of the fluid valve assembly 21 may be positioned in a desired position.

At least one driven element 62, for example a driven gear, a pinion, etc., may be formed on the main body 33 of the flow control member 29. It is understood, however, that the driven element may be formed on the main body 32 of the flow control member 28, if desired. The driven element 62 may extend outwardly and axially along the rotational axis of the main body 33. The driven element 62 may be configured to be coupled to a driving element or actuator 64 to cause the rotational movement of one or more of the flow control members 28, 29 about the rotational axis thereof in the first rotational direction and the opposite second rotational direction. The driving element/actuator 64 may be powered by any electric motor with an ability to generate rotary motion. For example, the driving element/actuator 64 may be driven by a stepper motor or a brushless DC (BLDC) motor. It is understood that other methods of actuation and causing the rotational movement of the flow control members 28, 29 within the fluid valve system 16 may be used.

An exemplary embodiment of the thermal management system may include a refrigerant circuit (e.g., refrigerant thermal management system (RTMS)) in heat exchange communication with a coolant circuit. The thermal management system may comprise a heater core (HC), a cooler core (CC), a power source (e.g. a battery), one or more heat exchangers (e.g., a condenser, an evaporator, a chiller (CH), a water-cooled chiller (WCC), a radiator, a low temperature radiator (LTR)), one or more valves (e.g., a bypass valve, a low temperature radiator bypass valve (LTRBP), a heater control valve), a bottle, one or more prime movers (e.g., a coolant pump, a refrigerant pump), and/or one or more blower assemblies. In some embodiments, the flow control member 26 may be a proportional 3-way heater core (HC) valve, the flow control member 27 may be a 8-way valve, the flow control member 28 may be a LTRBP (ON/OFF) valve, and the flow control member 29 may be a proportional 3-way cooler core (CC) valve. Point “A” may be located in cooling line for electrical components, point “B” may be located between the flow control valve 26/a water-cooled chiller (WCC1)/a heater core (HC) and a low temperature radiator (LTR), point “C” may be between the low temperature radiator (LTR) and the flow control valve 29/a chiller/a cooler core, and point “D” may be located between the flow control valve 29/the chiller/the cooler core (CC) and a power source. It is understood that the thermal management system may itself by modular in configuration with the described module 10.

It should be appreciated that the module 10 and the thermal management system 50 may include more or less components, valves, conduits, and other features and aspects than illustrated and described herein without departing from the spirit and scope of the present disclosure.

FIG. 7 is a table indicating rotational and/or ON/OFF positions for flow control members 26, 27, 28, 29 of the fluid valve assemblies 20, 21 of the module 10 of FIG. 1 when the module 10 is operating in various operating modes (e.g., Lower Mode End (LME); A: a fluid distribution in series through the chiller or the cooler core (CC), the low temperature radiator (LTR)) and a fluid distribution in series through the battery, a powertrain and the water-cooled chiller (WCC) and/or the heater core (HC); S: a fluid distribution in series through the power source, powertrain, and the water-cooled chiller (WCC) and/or the heater core (HC); P: a fluid distribution in parallel through the power source, the powertrain, and the water-cooled chiller (WCC) and/or the heater core (HC); and Upper Mode End (UME)).

When in an exemplary Mode LME, both of the flow control members 26, 27 of the first fluid valve assembly 20 have valve positions of 0 degrees and both of the flow control members 28, 29 of the second fluid valve assembly 21 have valve positions of 0 degrees.

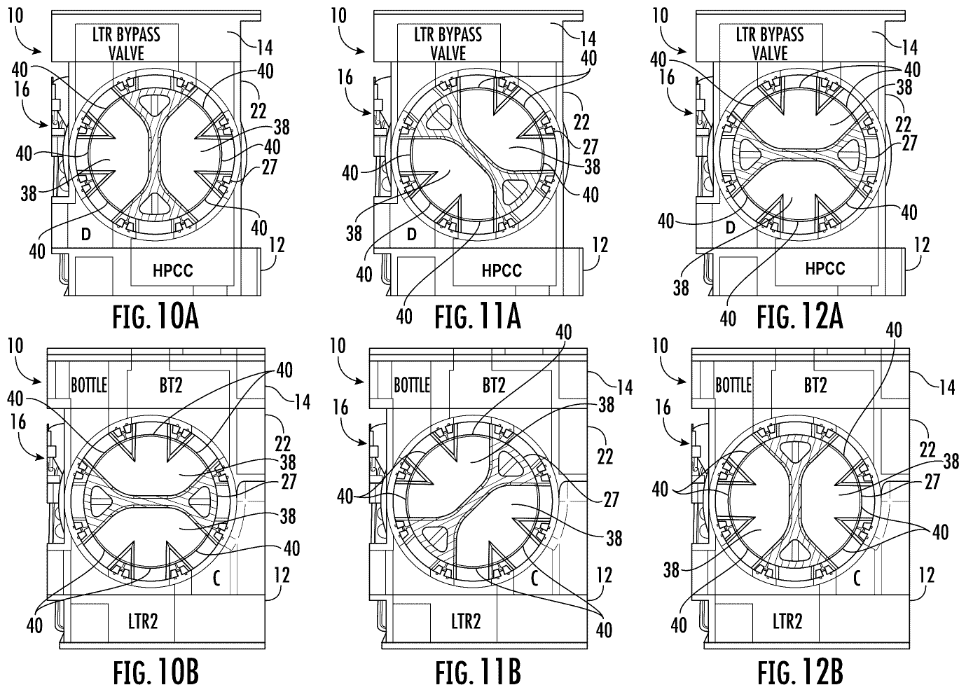

When in an exemplary Mode A, the flow control member 26 of the first fluid valve assembly 20 is proportional and has a valve position of one of 180, 135, and 90 degrees while the flow control member 27 of the first fluid valve assembly 20 has a valve position of 180 degrees. FIG. 10A illustrates a position of the fluid passageways 38 and fluid openings 40 within the first level of the flow control member 27 during Mode A and FIG. 10B illustrates a position of the fluid passageways 38 and fluid openings 40 within the second level of the flow control member 27 during Mode A. The flow control member 28 of the second fluid valve assembly 21 has a valve position of 180 degrees with the degassing connection 41 “ON” or 225 degrees with the degassing connection 41 “OFF” while the flow control member 29 of the second fluid valve assembly 21 is proportional and has a valve position of one of 180, 157.5, and 135 degrees. FIGS. 14A and 14B illustrate a position of the fluid passageways 38 and the fluid openings 40 within the flow control member 28 and the degassing connection 41 “ON” during Mode A.

When in an exemplary Mode S, the flow control member 26 of the first fluid valve assembly 20 is proportional and has a valve position of one of 180, 135, and 90 degrees while the flow control member 27 of the first fluid valve assembly 20 has a valve position of 225 degrees. FIG. 11A illustrates a position of the fluid passageways 38 and fluid openings 40 within the first level of the flow control member 27 during Mode S and FIG. 11B illustrates a position of the fluid passageways 38 and fluid openings 40 within the second level of the flow control member 27 during Mode S. The flow control member 28 of the second fluid valve assembly 21 has a valve position of 270 degrees with the degassing connection 41 “ON” or 315 degrees with the degassing connection 41 “OFF” while the flow control member 29 of the second fluid valve assembly 21 is proportional and has a valve position of one of 180, 157.5, and 135 degrees. FIGS. 13A and 13B illustrate a position of the fluid passageways 38 and the fluid openings 40 within the flow control member 28 and the degassing connection 41 “OFF” during Mode S.

When in an exemplary Mode P, the flow control member 26 of the first fluid valve assembly 20 is proportional and has a valve position of one of 180, 135, and 90 degrees while the flow control member 27 of the first fluid valve assembly 20 has a valve position of 270 degrees. FIG. 12A illustrates a position of the fluid passageways 38 and fluid openings 40 within the first level of the flow control member 27 during Mode P and FIG. 12B illustrates a position of the fluid passageways 38 and fluid openings 40 within the second level of the flow control member 27 during Mode P. The flow control member 28 of the second fluid valve assembly 21 has a valve position of 180 degrees with the degassing connection 41 “ON” or 225 degrees with the degassing connection 41 “OFF” while the flow control member 29 of the second fluid valve assembly 21 is proportional and has a valve position of one of 180, 157.5, and 135 degrees. FIGS. 14A and 14B illustrate a position of the fluid passageways 38 and the fluid openings 40 within the flow control member 28 and the degassing connection 41 “ON” during Mode P.

When in Mode UME, both of the flow control members 26, 27 of the first fluid valve assembly 20 have valve positions of 270 degrees and both of the flow control members 28, 29 of the second fluid valve assembly 21 have valve positions of 315 degrees.

Advantageously, the modules 10 has the ability to achieve three primary, or more, modes of operation with only two driving elements/actuators 54, 64; operating four flow control members 26, 27, 28, 29 independently with the only two driving elements/actuators 54, 64; and operating one of flow control members 26, 27, 28, 29 of at least one of the respective fluid valve assemblies 20, 21 proportionally while a remaining one of the flow control members 26, 27, 28, 29 of at least one of the respective fluid valve assemblies 20, 21 remains stationary in position.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A fluid valve system, comprising:
a first valve assembly including a first flow control member and a second flow control member in stacked relationship with the first flow control member, wherein the second flow control member is configured to be driven by the first flow control member, and wherein the first flow control member is configured to operably engage and rotate substantially independently from the second control member; and
a second valve assembly including a third flow control member and a fourth flow control member in stacked relationship with the third flow control member, wherein the third flow control member is configured to be driven by the fourth flow control member, wherein the fourth flow control member is configured to operably engage and rotate substantially independently from the third control member.

2. The fluid valve system of claim 1, wherein the first flow control member is configured to be driven by an actuator.

3. The fluid valve system of claim 1, wherein at least one of the first flow control member and the second flow control member includes a main body having at least fluid passageway formed therein.

4. The fluid valve system of claim 1, wherein the second flow control member comprises a first level including one or more fluid passageways and one or more fluid openings and a second level including one or more fluid passageways and one or more fluid openings.

5. The fluid valve system of claim 1, wherein the fourth flow control member is configured to be driven by an actuator.

6. The fluid valve system of claim 1, wherein at least one of the third flow control member and the fourth flow control member includes a main body having at least fluid passageway formed therein.

7. The fluid valve system of claim 1, further comprising a degassing connection formed in a housing of the fluid valve system.

8. The fluid valve system of claim 7, wherein the third flow control member selectively opens and closes the degassing connection.

9. A module, comprising:
at least one fluid manifold; and
a fluid valve system in fluid communication with the at least one fluid manifold, wherein the module is configured to selectively control a flow of one or more fluids through a thermal management system, wherein the fluid valve system comprises:
a housing;
a first valve assembly disposed in the housing, the first valve assembly including a first flow control member and a second flow control member in stacked relationship with the first flow control member, wherein the second flow control member is configured to be driven by the first flow control member, and wherein the first flow control member is configured to operably engage and rotate substantially independently from the second control member; and
a second valve assembly disposed in the housing, the second valve assembly including a third flow control member and a fourth flow control member in stacked relationship with the third flow control member, wherein the third flow control member is configured to be driven by the fourth flow control member, wherein the fourth flow control member is configured to operably engage and rotate substantially independently from the third control member.

10. The module of claim 9, wherein the first fluid valve assembly is configured to be independently operated from the second fluid valve assembly.

11. The module of claim 9, wherein a position of at least one of the flow control members depends on an operating mode of the thermal management system.

12. The module of claim 11, wherein the operating mode is a Mode A that permits a fluid distribution in series through the chiller or the cooler core (CC), the low temperature radiator (LTR) and a fluid distribution in series through the battery, a powertrain and the water-cooled chiller (WCC) and/or the heater core (HC).

13. The module of claim 11, wherein the operating mode is a Mode S that permits a fluid distribution in series through the power source, powertrain, and the water-cooled chiller (WCC) and/or the heater core (HC).

14. The module of claim 11, wherein the operating mode is a Mode P that permits a fluid distribution in parallel through the power source, the powertrain, and the water-cooled chiller (WCC) and/or the heater core (HC).

15. The module of claim 9, wherein the first flow control member is configured to be driven by at least one of a driving element and an actuator.

16. The module of claim 9, wherein the fourth control member is configured to be driven by at least one of a driving element and an actuator.

17. The module of claim 9, wherein each of the flow control members includes a main body having at least fluid passageway formed therein.

18. The module of claim 9, further comprising a degassing connection formed in a housing of the fluid valve system.

19. The module of claim 18, wherein the third flow control member selectively opens and closes the degassing connection.

20. A method of operating a module, comprising:
providing a module comprising at least one fluid manifold and a fluid valve system, the fluid valve system comprising:
a housing;
a first valve assembly disposed in the housing, the first valve assembly including a first flow control member and a second flow control member in stacked relationship with the first flow control member, wherein the second flow control member is configured to be driven by the first flow control member, and wherein the first flow control member is configured to operably engage and rotate substantially independently from the second control member; and
a second valve assembly disposed in the housing, the second valve assembly including a third flow control member and a fourth flow control member in stacked relationship with the third flow control member, wherein the third flow control member is configured to be driven by the fourth flow control member, wherein the fourth flow control member is configured to operably engage and rotate substantially independently from the third control member;
causing a rotational movement of the first flow control member in a first direction to selectively position the second flow control member in a desired position;
causing a rotational movement of the first flow control member in an opposite second direction to selectively position the first control member in a desired position;
causing a rotational movement of the fourth flow control member in the first direction to selectively position the third flow control member in a desired position; and
causing a rotational movement of the fourth flow control member in the second direction to selectively position the fourth control member in a desired position;
wherein the module is configured to operate in at least three modes.
